(19) United States
(12) Patent Application Publication
(10) Pub. No.: US 2012/0133586 A1
(43) Pub. Date: May 31, 2012

(54) INPUT DEVICE

(75) Inventors: Kenji Nishimura, Osaka (JP); Masaki Sawada, Osaka (JP); Tamotsu Yamamoto, Hyogo (JP)

(73) Assignee: Panasonic Corporation, Osaka (JP)

(21) Appl. No.: 13/296,288

(22) Filed: Nov. 15, 2011

(30) Foreign Application Priority Data
Nov. 26, 2010 (JP) 2010-263360

(51) Int. Cl. G06F 3/033

(52) U.S. Cl. 345/158

(57) ABSTRACT

An input device comprises a rotatable magnet member, a lower casing and an upper casing. The rotatable magnet member has a magnet, a spherical part and a rod-like shaft. The magnet is formed into a ring-shaped disc with a through hole in the center, and magnetized with N and S poles alternately along the circumferential direction. The rod-like shaft having a flange portion near a first end is inserted in the through hole, and both ends protrude from the through hole. The lower casing rotatably supports the rod-like shaft of the rotatable magnet member. There is a space provided between an outer peripheral surface of a part of the rod-like shaft inside the through hole and an inner wall of the through hole over the entire peripheries, and the flange portion is press-fitted and fixed to the spherical part.

### TECHNICAL FIELD

The technical field relates to input devices used mainly for input controller units of various electronic apparatuses.

### BACKGROUND ART

Various electronic apparatuses such as mobile phones and personal computers have been advancing in recent years toward higher performance and downsizing. This trend of advancement accompanies diversification in configuration of input devices for input controller units of various electronic apparatuses, for example, there is a continuous rise in number of electronic apparatuses equipped with trackball devices as the input devices having solid spheres to be rotated for operation. With reference to the accompanying drawings, description is provided hereinafter of a trackball device used as the input device.

FIG. 9 is a sectional view of a conventional trackball device, FIG. 10 is an exploded perspective view of the conventional trackball device, and FIG. 11 is a perspective view of the conventional trackball device before assembling a mechanism unit and a substrate unit.

As shown in FIG. 10, lower casing 1 has a cross shape in the top view, and it has protruding portions 2 extending in four directions from the respective sides and through hole 3 in the center. Lower casing 1 is formed of an insulation resin. A pair of protruding portions 2 located in point symmetry with respect to the center of lower casing 1 in the top view have one each of latching projections 2a in the center of side surfaces at their end portions. The remaining pair of protruding portions 2 have one each of latching recesses 2b in side surfaces at their end portions.

Lower casing 1 has plate spring 7, one end of which is embedded and fixed to an inner wall of through hole 3 as shown in FIG. 9. The other end portion of plate spring 7 is located inside through hole 3. Plate spring 7 is bent upward near the portion where it is embedded so that the other end portion located inside through hole 3 stays in a position higher than the embedded portion.

Rollers 9 are formed into generally a cylindrical shape, and they are disposed individually on protruding portions 2. Ring magnet 10 has a cylindrical shape magnetized with N and S poles alternately at predetermined angles along the circumferential direction, and it is attached to one end of each of rollers 9. In describing more about positional relation in detail, each of rollers 9 is disposed on respective one of protruding portions 2 in such an orientation that the axis of roller 9 is orthogonal to the extending direction of protruding portion 2. As a result, each of ring magnets 10 is situated in one of four spaces at corners formed by adjoining protruding portions 2. In other words, four rollers 9 are disposed in their positions at the corners of a regular square in the top view.

Ball 12 defining a control element is placed on the other end portion of plate spring 7 inside through hole 3, and it is thrust upward.

Upper casing 14 has circular hole 15 of a diameter smaller than the diameter of ball 12 in the center thereof. Upper casing 14 has protruding portions 16 extending in four directions from the respective sides in a corresponding manner to protruding portions 2 of lower casing 1. Upper casing 14 is formed of an insulation resin. Protruding portions 16 have hook portions 17 extending downward from their underside surfaces. Each of rollers 9 is retained in a rotatable manner between a lower open space of hook portions 17 and an upper surface of protruding portion 2 of lower casing 1.

Cover 19 is made of a metal plate, and it is placed from the upper side of upper casing 14 in a position overlaying upper surfaces of protruding portions 16. Cover 19 has a pair of first legs 20 and a pair of second legs 21 extending downward in a manner to confront the side surfaces at the ends of protruding portions 16 mated with protruding portions 2. First leg 20 is provided with rectangular hole 20A near the end of it. Second leg 21 is provided with latching tabs 21A at the lower end of it.

Latching projections 2a provided on protruding portions 2 of lower casing 1 are engaged with rectangular holes 20A in first legs 20, whereas latching tabs 21A of second legs 21 are connected to latching recesses 2b formed in protruding portions 2 of lower casing 1. Cover 19, lower casing 1, rollers 9, ball 12 and upper casing 14 are assembled in this manner to complete the mechanism unit as shown in FIG. 11. Ball 12 has a portion protruding above circular hole 15. The mechanism unit is so constructed that the protruding portion can be manipulated for turning operation and pressing operation with a finger and the like object.

Wiring board 23 is provided in a position facing the bottom side of the mechanism unit, and four magnetic sensing elements 24 such as hall elements are mounted to an upper surface of wiring board 23 in positions confronting individual ring magnets 10. As a result, magnetic sensing elements 24 are so arranged that their positions correspond to individual corners of a regular square in the top view. There is also one push switch 25 mounted in the center position of the square in the top view. The substrate unit thus comprises wiring board 23, magnetic sensing elements 24 and push switch 25.

The mechanism unit and the substrate unit are assembled in a manner to vertically face each other with a predetermined space between individual ring magnets 10 and corresponding sensing elements 24. In addition, ball 12 is disposed above push switch 25 so that it confronts push switch 25 through the other end portion of plate spring 7 as shown in FIG. 9.

The trackball device constructed as above operates in a manner which is described next.

When a user turns ball 12 by manipulating the upwardly protruding portion, ball 12 shifts in the turning direction while being depressed slightly and comes into contact with one of rollers 9 located at one side corresponding to the turning direction, and causes roller 9 to rotate along with the rotation of ball 12. Ring magnet 10 also rotates with roller 9. Magnetic sensing element 24 in the position confronting ring magnet 10 detects a change in magnetism caused by the rotation of ring magnet 10, and produces a given output. A controller unit of electronic apparatus (not shown) determines a state of turning manipulation of ball 12 according to this output signal, and activates a predetermined function of the electronic apparatus.

When the user depresses the protruding portion of ball 12, on the other hand, ball 12 shifts downward while pressing plate spring 7, and depresses push switch 25 with the underside at the other end portion of plate spring 7 to produce a switching signal. The controller unit of the apparatus also detects this signal of push switch 25 and activates a predetermined function of the apparatus.

Each of the above manipulations, for instance, moves a cursor or a pointer in a display of the apparatus according to the rotation of ball 12, and the depressing manipulation of ball 12 enters a selected program.

Japanese Patent, No. 4,187,035, for example, is one of the known prior art documents.

### SUMMARY

The conventional trackball device has a structure comprising magnets 10 exposed to the outside. For this reason, they are prone to the risk of damages in the process of manufacturing, and therefore require extra care while assembling.

An input device comprises a rotatable magnet member, a lower casing, an upper casing and a magnetic sensing element. The rotatable magnet member has a magnet, a spherical part and a rod-like shaft. The magnet is formed into a ring-shaped disc with a through hole in the center, and magnetized with N and S poles alternately along the circumferential direction. The spherical part is formed of a resin for covering the magnet except for areas opened into the through hole. The rod-like shaft having a flange portion near a first end is inserted in the through hole, and both ends protrude from the through hole. The lower casing rotatably supports the rod-like shaft of the rotatable magnet member. The upper casing is connected with the lower casing, and it has an opening that exposes an upper part of the rotatable magnet member to the exterior. The magnetic sensing element is disposed in a position under the influence of magnetism of the magnet. There is a space provided between an outer peripheral surface of a part of the rod-like shaft situating inside the through hole and an inner wall of the through hole over their entire peripheries, and the flange portion is fixed to the spherical part by press fitting.

There is thus provided the input device capable of performing stable rotational movement with higher quality than before.

### BRIEF DESCRIPTION OF DRAWINGS

FIG. 1 is a sectional view of an input device according to an exemplary embodiment;

FIG. 2 is a perspective view of the input device according to the exemplary embodiment before a mechanism unit and substrate unit are assembled;

FIG. 3 is an exploded perspective view of the input device according to the exemplary embodiment;

FIG. 4 is a plan view of the input device according to the exemplary embodiment with an upper casing removed;

FIG. 5 is a sectional view taken along the line 5-5 in FIG. 4;

FIG. 6 is an outer perspective view of a lower casing, a main part of the input device according to the exemplary embodiment;

FIG. 7 is a sectional view of a rotatable magnet member, another main part of the input device according to the exemplary embodiment;

FIG. 8 is an exploded perspective view of the rotatable magnet member, the main part of the input device according to the exemplary embodiment;

FIG. 9 is a sectional view of a trackball device known as a conventional input device;

FIG. 10 is an exploded perspective view of the trackball device shown in FIG. 9; and

FIG. 11 is a perspective view of the trackball device shown in FIG. 9 before assembling a mechanism unit and a substrate unit.

### DETAILED DESCRIPTION OF THE INVENTION

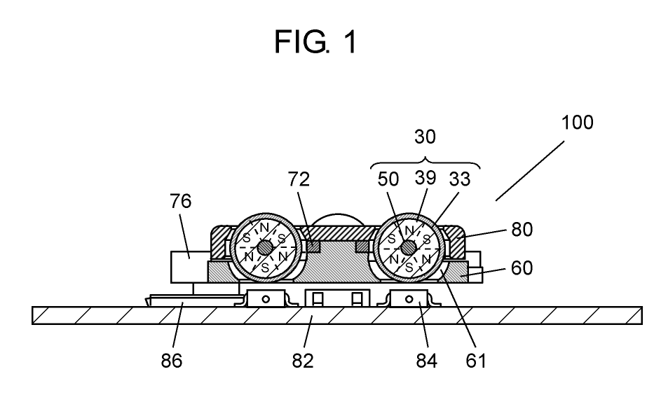

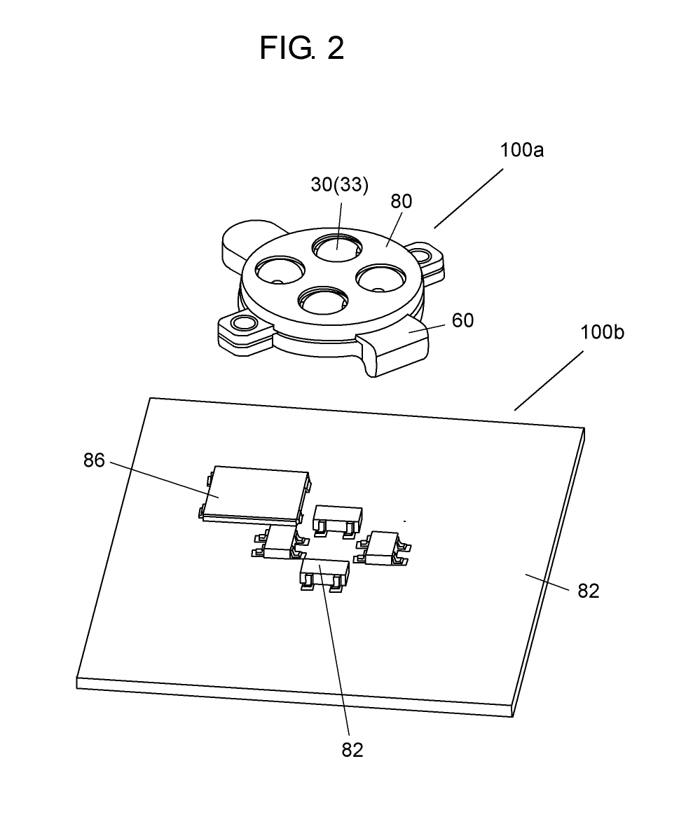

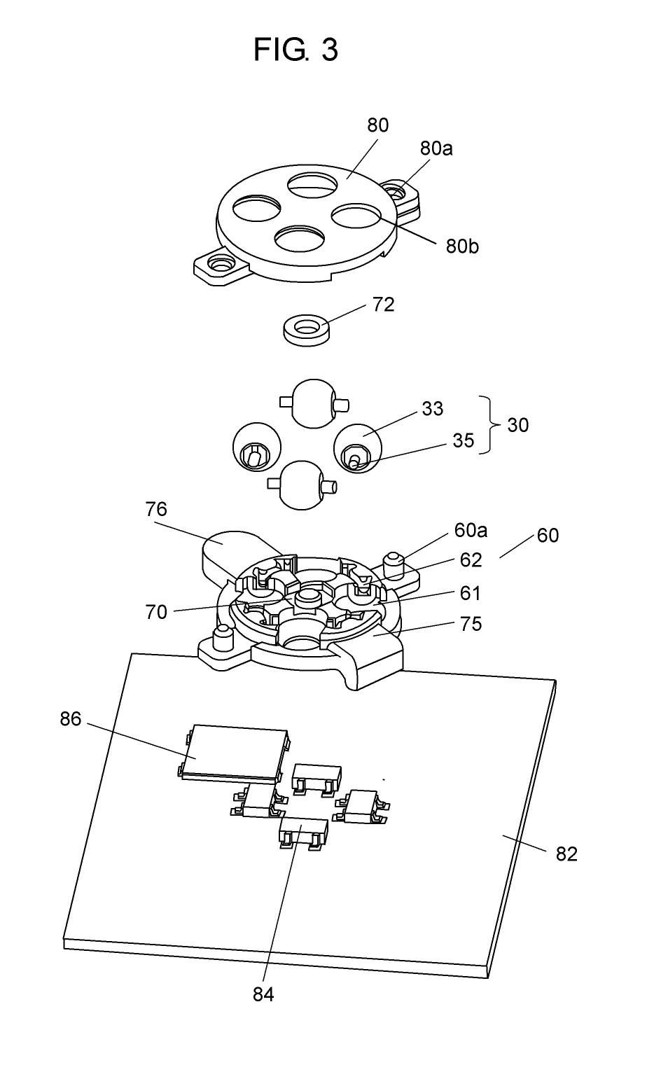

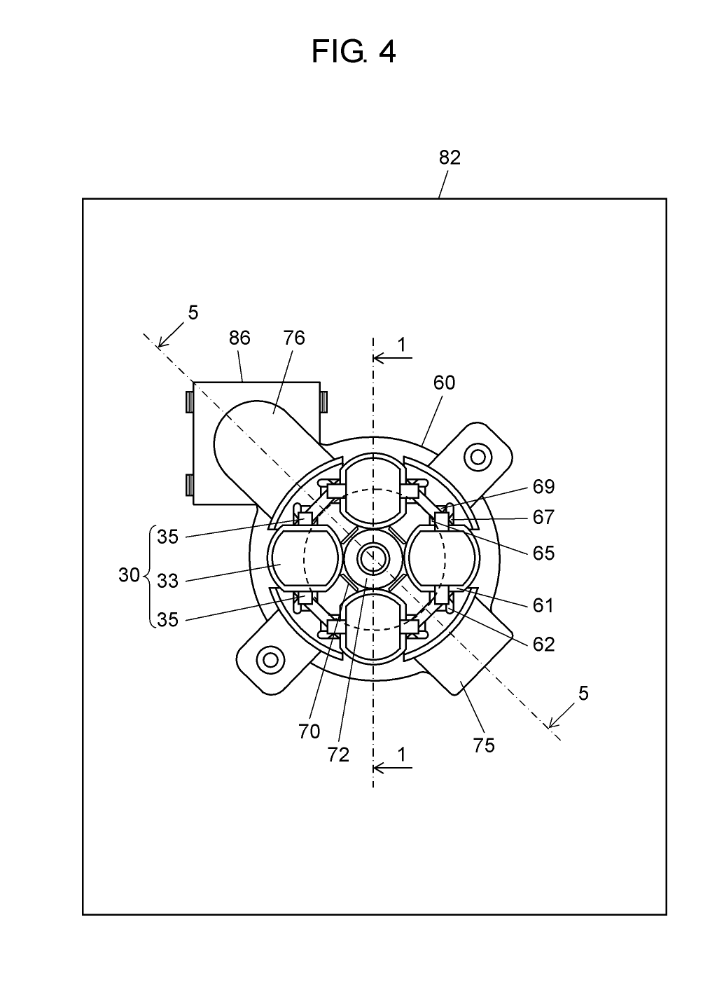

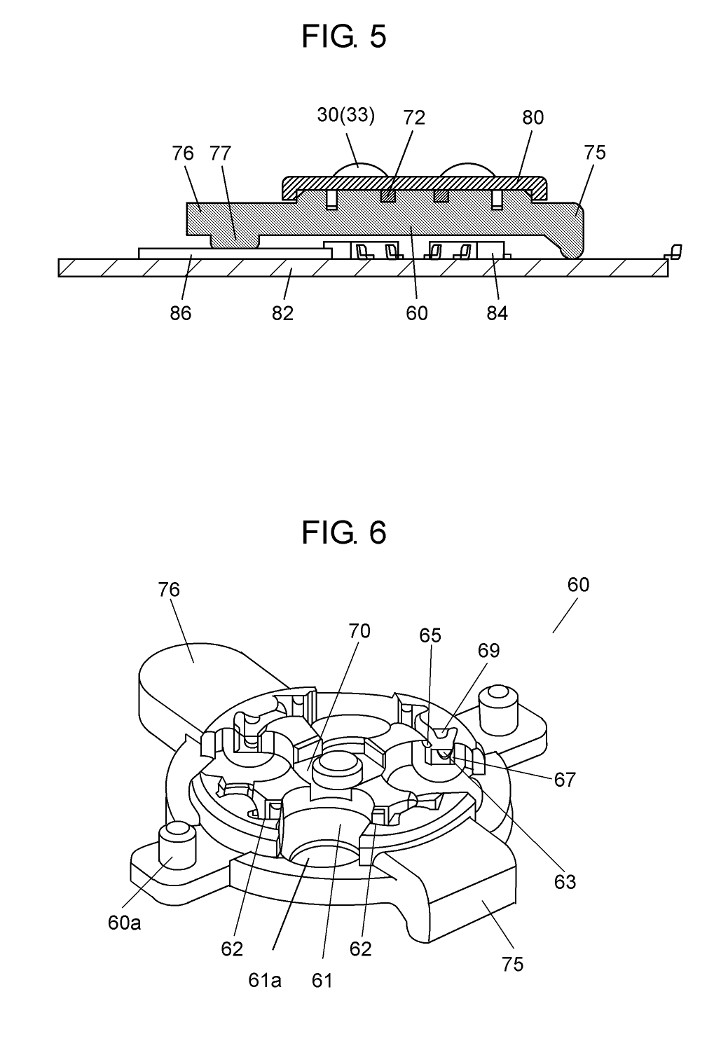

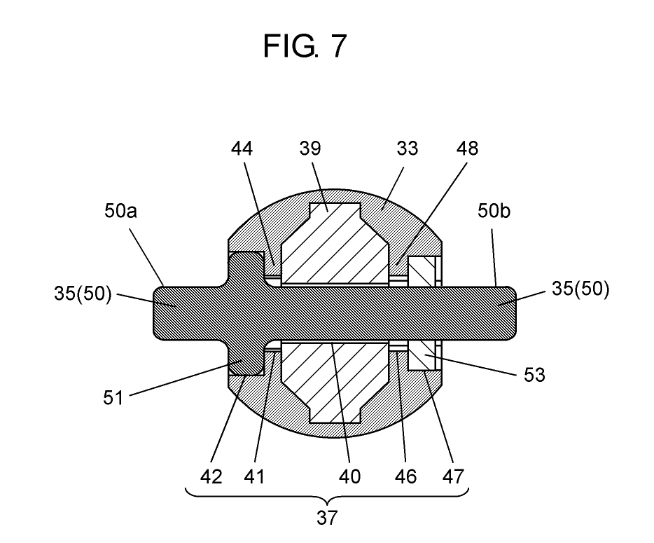

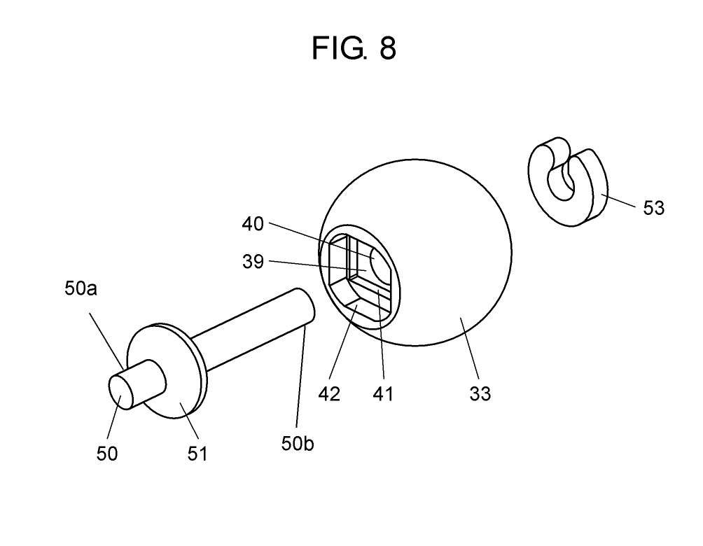

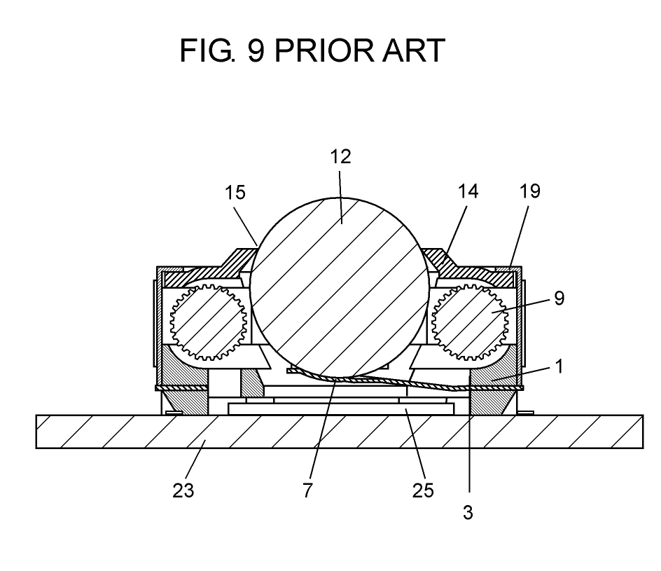

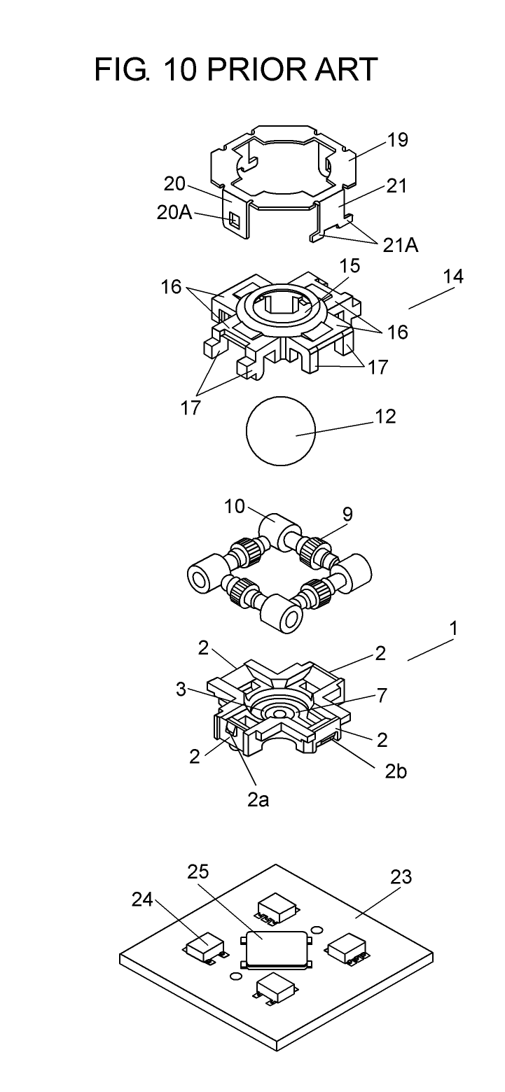

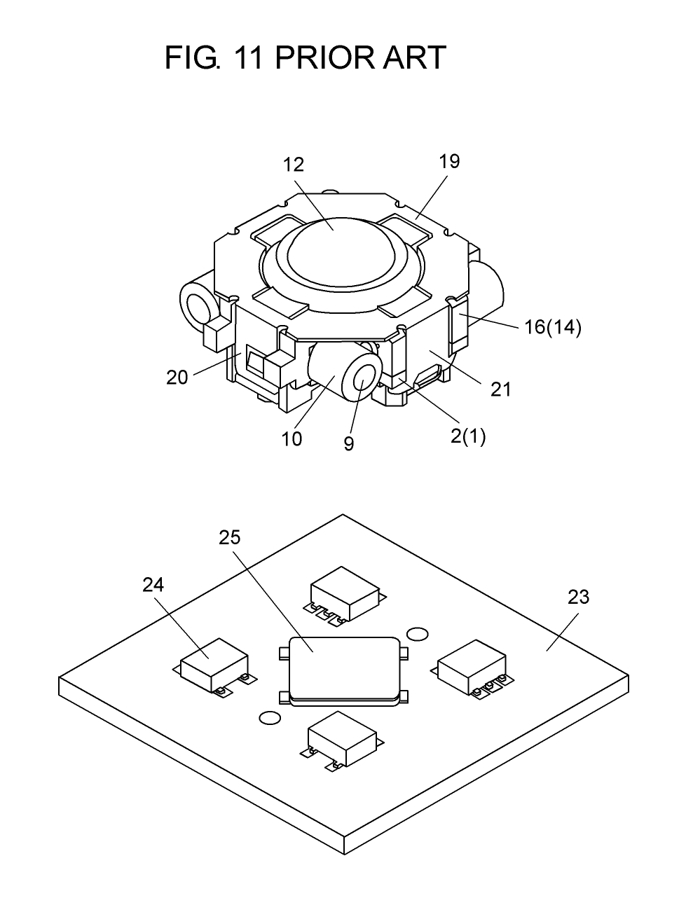

FIG. 1 is a sectional view of an input device according to this exemplary embodiment. FIG. 2 is a perspective view of the input device of this embodiment before a mechanism unit and substrate unit are assembled. FIG. 3 is an exploded perspective view of the input device of this embodiment. FIG. 4 is a plan view of the input device of this embodiment with an upper casing removed. Note that the sectional view shown in FIG. 1 is taken along the line 1-1 in FIG. 4. FIG. 5 is a sectional view taken along the line 5-5 in FIG. 4, and FIG. 6 is an outer perspective view of a lower casing, a main part of the input device of this embodiment. FIG. 7 is a sectional view of a rotatable magnet member according to this embodiment. FIG. 8 is an exploded perspective view of the rotatable magnet member of this embodiment.

As shown in FIG. 2, input device 100 of this embodiment comprises mechanism unit 100a and substrate unit 100b. Mechanism unit 100a includes rotatable magnet member 30, lower casing 60 and upper casing 80. Rotatable magnet member 30 includes magnet 39, spherical part 33, rod-like shaft 50 and fastening part 53, as shown in FIGS. 1, 7 and 8. Magnet 39 is formed into a ring-shaped disc with central through hole 40, and magnetized with N and S poles alternately along the circumferential direction. Spherical part 33 is made of a sphere-shaped resin for covering magnet 39 except for areas opened into central through hole 40. Rod-like shaft 50 has flange portion 51 near first end 50a, and it is inserted in central through hole 40 in a manner that both ends protrude from through-hole portion 37. Fastening part 53 is fitted in second end 50b of rod-like shaft 50 and it fixes rod-like shaft 50 to spherical part 33. Lower casing 60 rotatably supports rod-like shaft 50 of rotatable magnet member 30. Upper casing 80 has opening 80b provided to expose an upper part of rotatable magnet member 30 to the exterior, and it is connected with lower casing 60.

Spherical part 33 has a spherical shape in outer appearance, and it is formed of a resin (refer to FIG. 1 to FIG. 3 and FIG. 5). Magnet 39 is secured inside spherical part 33 by insert molding (refer to FIG. 7 and FIG. 8). Magnet 39 is formed of a ferrite, an Nd—Fe—B alloy or the like material into a diameter of about 2 to 3 mm. Magnet 39 has central through hole 40 in the center thereof. Central through hole 40 is so formed as to have the center in line with the center of spherical part 33, and it constitutes a part of through-hole portion 37 of rotatable magnet member 30. Magnet 39 is magnetized with N and S poles alternately and contiguously at intervals of 60 degrees, for instance, along the ring-shaped circumferential direction. Rotatable magnet member 30 has single through-hole portion 37 (refer to FIG. 7) that penetrates through spherical part 33 in a diametric direction thereof, and one rod-like shaft 50 is inserted in through-hole portion 37. Shaft part 35 comprises two end portions of rod-like shaft 50 that protrude from through-hole portion 37, details of which will be described later.

As described above, spherical part 33 defining a shell portion of rotatable magnet member 30 has its shape formed except for areas in the proximity of central through hole 40 of magnet 39 as shown in FIG. 7 and FIG. 8. In other words, spherical part 33 is provided with first opening 41 and second opening 46 perforated in a manner to expose central through hole 40. Spherical part 33 is also provided with first recess 42 and second recess 47 in continuity to first opening 41 and second opening 46 respectively in positions outside of first opening 41 and second opening 46. First recess 42 and second recess 47 have their opening areas larger than diameters of first opening 41 and second opening 46 respectively in the side view. First recess 42 and second recess 47 are so formed as to be caved in from the outside of spherical part 33 such that they become a concaved shape toward the sides of the ring-shaped disc of magnet 39. A part of bottom surface inside first recess 42 other than first opening 41 serves as first seating portion 44, and a part of bottom surface inside second recess 47 other than second opening 46 serves as second seating portion 48. In other words, first seating portion 44 and second seating portion 48 are unitary molded with the resin that forms spherical part 33 of this structure. It thus becomes possible to reduce a number of component parts.

As has been described, rotatable magnet member 30 has a structure wherein magnet 39 is covered entirely within spherical part 33 formed of the resin, and central through hole 40 of magnet 39 communicates to the outside in a straight line through individual openings 41, 46 and recesses 42 and 47. Through-hole portion 37 of rotatable magnet member 30 is thus made up of central through hole 40, individual openings 41 and 46, and individual recesses 42 and 47.

Rod-like shaft 50 comprises a straight rod having generally a circular shape in cross section orthogonal to the axial direction, and flange portion 51 formed near first end 50a in a manner to extend in the direction orthogonal to the axial direction as shown in FIG. 7 and FIG. 8. Rod-like shaft 50 is inserted with second end 50b into through-hole portion 37 of spherical part 33. A part of rod-like shaft 50 inserted in through-hole portion 37 has a smaller diameter than an inner diameter of central through hole 40 of magnet 39. That is, a predetermined space is provided between an outer peripheral surface of rod-like shaft 50 and an inner wall of central through hole 40 over their entire peripheries. Flange portion 51 is press-fitted into first recess 42. In other words, flange portion 51 is press-fitted into first recess 42 so that first seating portion 44 lies between flange portion 51 and one side of magnet 39 confronting flange portion 51. Fastening part 53 having an inner diameter of generally equal in dimension as an outer diameter of rod-like shaft 50, such as a C-ring or O-ring, is placed on second end 50b of rod-like shaft 50, and press-fitted until fastening part 53 abuts against second seating portion 48 inside second recess 47. In other words, fastening part 53 is press-fitted into second recess 47 so that second seating portion 48 lies between fastening part 53 and the other side of magnet 39 confronting fastening part 53. Rod-like shaft 50 is thus fixed to spherical part 33 in a manner not rotatable with respect to each other by press-fitting flange portion 51 at first end 50a and fastening part 53 at second end 50b into first recess 42 and second recess 47 respectively, as illustrated above. In this configuration, the end portions of rod-like shaft 50 protrude from spherical part 33 to the outside at both first end 50a and second end 50b, and they constitute shaft part 35.

Description is provided next of the processes of manufacturing rotatable magnet member 30.

Rod-like shaft 50 is inserted with second end side 50b into spherical part 33 in which magnet 39 is insert-molded, as shown in FIG. 8. Second end 50b of rod-like shaft 50 is inserted in order of first recess 42, first opening 41, central through hole 40 of magnet 39, second opening 46 and second recess 47. Flange portion 51 of rod-like shaft 50 is then press-fitted into first recess 42 until the surface of flange portion 51 at the side of second end 50b comes abutted upon first seating portion 44. A subassembly item of this state is called a work in process of rotatable magnet member 30. Since the work in process at this stage has a structure that supports flange portion 51 with first seating portion 44 made of the resin, it can protect magnet 39 from accidental damages. Although shapes of flange portion 51 and first recess 42 need not be specifically limited, it is desirable here that flange portion 51 is formed into a circular shape and first recess 42 into generally a square shape in the side view. Since such shapes keep flange portion 51 in contact with first recess 42 only partly rather than the entire side surface, they maintain uniform condition of press-fit at the contact areas, and provide superior working efficiency of press fitting. This structure also helps facilitate adjustment of the fitting condition simply by correcting slightly the shapes of flange portion 51 and first recess 42.

In the work in process, second end 50b of rod-like shaft 50 protrudes outward from spherical part 33. In the next step, fastening part 53 such as a C-ring or O-ring that does not turn freely is inserted from the tip of second end 50b of rod-like shaft 50. Fastening part 53 is then pressed toward spherical part 33 into second recess 47 until one side of fastening part 53 facing second end 50b of rod-like shaft 50 abuts against second seating portion 48. Since fastening part 53 is also supported with second seating portion 48 made of the resin, this structure can protect magnet 39 from accidental damages. While shapes of fastening part 53 and second recess 47 need not be specifically limited so long as fastening part 53 can be press-fitted into second recess 47, it is desirable to make their shapes similar to those of flange portion 51 and first recess 42 so as to obtain the like advantage in addition to allowing the use of fastening part 53 of low cost. That is, it is more desirable to form fastening part 53 into a circular shape and second recess 47 into generally a square shape in the side view.

As discussed above, rod-like shaft 50 is integrated with spherical part 33 by being press-fitted into and retained at the both ends with spherical part 33. Rotatable magnet member 30 is hence constructed in the above manner. Rotatable magnet member 30 can be obtained at low cost with a small number of man-hours by virtue of this structure.

Mechanism unit 100a is constructed by using four sets of these rotatable magnet members 30, and description is continued further about mechanism unit 100a.

Lower casing 60 is formed of an insulation resin such as polyacetal, and an upper surface of it is provided with four semi-spherical recesses 61, as shown in FIGS. 1, 3 and 6. These four semi-spherical recesses 61 are formed in positions of equal distance from the center of lower casing 60 at intervals of 90 degrees. In other words, each of the four semi-spherical recesses 61 is arranged to be located at the center of each segment of an imaginary regular square according to a top view. Inner walls of semi-spherical recess 61 are formed into such a shape that the diameter becomes smaller toward the bottom side, and through holes 61a are formed to penetrate vertically in the bottom center positions of the individual semi-spherical recesses as shown in FIG. 6. There are straight grooves 62 stretched outward from each of semi-spherical recesses 61 along of a diametrically extended line of respective semi-spherical recess 61. In other words, each of semi-spherical recesses 61 is provided with two straight grooves 62 that are stretched toward the outside of semi-spherical recess 61 in the opposite directions with respect to each other along the segment of the generally regular square in phantom as viewed from the top. That is, two adjoining straight grooves 62 stretched individually from adjacent semi-spherical recesses 61 are in relation orthogonal to each other.

Rotatable magnet member 30 is disposed inside a pair of straight grooves 62 and semi-spherical recess 61. To be more specific, a lower portion of spherical part 33 is disposed inside semi-spherical recess 61 and a pair of shaft parts 35 in the corresponding pair of straight grooves 62 to make rotatable magnet member 30 freely rotatable.

Description is provided here of a structure of straight grooves 62 and a supporting mechanism of shaft parts 35 inside straight grooves 62. Each of straight grooves 62 has terrace 63 in an end surface at the far side of semi-spherical recess 61, as shown in FIG. 6. A bottom surface of terrace 63 is formed above a bottom surface of semi-spherical recess 61. Each of straight grooves 62 is also provided with one of first support 65 and second support 67 in a form of protrusion having a semi-circular cylindrical shape with a top view of generally a crescent shape on each of confronting wall surfaces of straight groove 62. First support 65 and second support 67 are provided in positions shifted with respect to each other along the axial direction of straight groove 62. Shaft parts 35 of rod-like shaft 50 of rotatable magnet member 30 have shapes so formed that they can be supported at a height position of the central axis of shaft parts 35 from their outer peripheries toward the central axis with protruding central ridges of first support 65 and second support 67. There is also third support 69 of a semi-circular cylindrical shape with the top view of generally a crescent shape on each of inner walls at the ends in the axial direction of straight grooves 62. Each of third supports 69 are formed in a manner to confront the surfaces at the tip ends in the axial direction of shaft parts 35, such that the protruding center parts of third supports 69 can support the surfaces at the tip ends in the axial direction of shaft parts 35, including the height position of the central axis of shaft parts 35. In this embodiment, any of the three types of supports 65, 67 and 69 may be protruded into different shapes other than the protrusions of semi-circular cylindrical shape with the top view of generally the crescent shape. For instance, first supports 65 and second supports 67 can be of any other shape capable of supporting shaft parts 35 of rotatable magnet member 30 in point contact even if shaft parts 35 shift vertically to a small extent, such as a vertically extending triangular prism shape having ridges of which one is used for supporting shaft parts 35. In addition, third supports 69 can be of another shape such as a triangular prism shape so that the surfaces at the tip ends in the axial direction of shaft parts 35 can be supported with one of ridges of each of the triangular prisms, including a case when shaft parts 35 shift vertically to a small extent. Furthermore, third supports 69 may also be formed into any other shape such as a spherical shape, a circular truncated cone or a truncated pyramid that is capable of supporting only in point contact at the axial center positions in the end surfaces of shaft parts 35.

Shaft parts 35 of rotatable magnet member 30 are supported inside straight grooves 62 with the tip ends of shaft parts 35 placed on terraces 63 in linear contact therewith in the axial direction. At the same time, shaft parts 35 are supported in position with their surfaces at the tip ends held in the axial direction by third supports 69 and their outer peripheries by first supports 65 and second supports 67 toward the central axis (refer to FIG. 4).

As discussed above, rotatable magnet member 30 is supported rotatably inside the pair of straight grooves 62 corresponding to the pair of shaft parts 35. In addition, spherical part 33 is disposed in semi-spherical recess 61. Four rotatable magnet members 30 are positioned to have a relation that they are at the centers of the individual segments of generally an imaginary regular square according to a top view as shown in FIG. 4.

Rotatable magnet members 30 are supported individually in a rotatable manner in their respective diametric directions of an imaginary circle connecting the centers of spherical parts 33. It is preferable that four rotatable magnet members 30 are arranged with spacing of about 3 mm to 5 mm from one another to make all of four spherical parts 33 touchable at the same time with one finger.

Lower casing 60 has magnetic plate setting channel 70 of an annular shape in the center area of upper surface encircled by four semi-spherical recesses 61 (refer to FIG. 4). There is annular magnetic plate 72 fixed to magnetic plate setting channel 70 (refer to FIG. 1, FIG. 4 and FIG. 5). The provision of magnetic plate 72 can avoid warpage of lower casing 60 and prevent rotatable magnet members 30 from being turned unintentionally while not in use by attracting magnets 39 of rotatable magnet members 30. Shape of magnetic plate 72 need not be specifically limited the ring-shape. Magnetic plate 72 may be individually disposed corresponding to each of rotatable magnet members 30. In addition, shape of magnetic plate setting channel 70 need not be specifically limited. Furthermore magnetic plate 72 may be disposed at a side of an upper face of lower case 60 or any other positions thereof. Moreover magnetic plate 72 may be disposed at other members except for lower case 60.

Furthermore, lower casing 60 is provided with first outer projecting portion 75 and second outer projecting portion 76 on the lateral surface (refer to FIG. 3 to FIG. 5). First outer projecting portion 75 is formed into a shape of generally the letter L with the tip of the projecting end bent downward. Second outer projecting portion 76 has pressing bump 77 on the underside as shown in FIG. 5.

Upper casing 80 has openings 80b corresponding to rotatable magnet members 30 placed on lower casing 60, and upper casing 80 is connected to lower casing 60 with the upper parts of spherical parts 33 of rotatable magnet members 30 protruded through individual openings 80b (refer to FIG. 1, FIG. 2 and FIG. 5). Upper casing 80 also has the function of preventing shaft parts 35 from coming off upward. Upper casing 80 may be made by using any of a resin material such as polycarbonate, a magnetic plate such as stainless steel and the like. Although no specific restriction applies to the method of connecting upper casing 80 to lower casing 60, upper casing 80 and lower casing 60 are connected in this embodiment as shows in FIG. 3. That is, dowel pins 60a provided on the side spaces of lower casing 60 are inserted in fixing holes 80a in the side areas of upper casing 80. Upper casing 80 and lower casing 60 are connected by crimping the top ends of dowel pins 60a.

According to this embodiment, mechanism unit 100a of input device 100 is constructed as discussed above.

Substrate unit 100b comprises wiring board 82, magnetic sensing elements 84 and push switch 86, as shown in FIG. 1 through FIG. 5. Magnetic sensing elements 84 are mounted on wiring board 82 in positions confronting their respective spherical parts 33 of rotatable magnet members 30. Hall elements or other similar devices are suitable for use as magnetic sensing elements 84. Push switch 86 is mounted on wiring board 82 in a position confronting pressing bump 77 on second outer projecting portion 76. Substrate unit 100b may be covered with an insulation sheet to improve a waterproofing property. As for push switch 86, it is preferable to use a switch of such type that can turn into on state with a tactile response when depressed though this is not specifically restrictive.

Mechanism unit 100a is placed on substrate unit 100b so that the lower end of first outer projecting portion 75 abuts on an upper surface of wiring board 82 as shown in FIG. 5. In addition, pressing bump 77 of second outer projecting portion 76 is in contact with push switch 86. This structure enables push switch 86 to become on and off when second outer projecting portion 76 is pressed downward with the lower end of first outer projecting portion 75 acting as a fulcrum. With the unit in this state, spherical parts 33 of rotatable magnet members 30 stay confronting their respective magnetic sensing elements 84 over a predetermined vertical space between them. Mechanism unit 100a is brought into a mounting position in alignment with substrate unit 100b with the top of upper casing 80 exposed, for instance, by pressing down the peripheral area of mechanism unit 100a with an equipment enclosure from the upper side.

Input device 100 constructed as illustrated above operates in a manner, which is described next.

In the normal state when the device is not being operated, four rotatable magnet members 30 remain fixed by an attractive force exerted on annular magnetic plate 72 secured to lower casing 60 that pulls magnets 39 toward annular magnetic plate 72. It is by virtue of this structure to hold four rotatable magnet members 30 steadily and maintain the normal state even when unexpected vibration is exerted on the input device.

With the input device in this normal state, a user makes a turning manipulation of spherical parts 33 of rotatable magnet members 30 by sliding a finger or the like object in parallel along the top surface of upper casing 80. At this same time, any of rotatable magnet members 30 that is rotatable in response to the sliding manipulation of the user rotates for a given degree since each pair of shaft parts 35 are disposed in the corresponding pair of straight grooves 62 such that rotational movement of each rotatable magnet member 30 is limited only to a specific direction. There are cases in the sliding manipulation that only two of rotatable magnet members 30 or all four of them rotate, for example, depending on the sliding direction. It is also noted that an activating force of push switch 86 and a distance from the bottom end of first outer projecting portion 75 to pressing bump 77 are set properly so that push switch 86 is not unintentionally pushed with pressing bump 77 during the sliding manipulation.

When any of rotatable magnet members 30 rotates in response to the above-said sliding manipulation by the user, magnet 39 integrated within spherical part 33 rotates synchronously. This causes a change in magnetism, and magnetic sensing element 84 detects this change in the magnetism and forwards an output signal corresponding to it to a controller unit of an apparatus (not shown). The controller unit of the apparatus carries out an arithmetic operation according to the signal from each of magnetic sensing elements 84 corresponding to four rotatable magnet members 30. The controller unit determines a direction and a distance of the manipulation made by the user, and executes a predetermined function of the apparatus according to a result of the determination.

When the user stops the sliding manipulation described above, magnets 39 are attracted to annular magnetic plate 72, and four rotatable magnet members 30 return to the state in which they stay attracted to annular magnetic plate 72. Accordingly, the individual rotatable magnet members 30 return to the normal state where they become stable at a standstill.

Here, the sliding manipulation of rotatable magnet members 30 by the user is made on spherical parts 33 formed of a resin rather than directly to magnets 39. It is thus possible to prevent magnets from being damaged accidentally due to external shocks attributable to the sliding manipulation and the like. In addition, there are first seating portion 44 and second seating portion 48 formed of resin 31 interposed between flange portion 51 and magnet 39 and also between fastening part 53 and magnet 39 in each of spherical parts 33. Furthermore, a predetermined space is provided between the inner wall of central through hole 40 and the outer peripheral surface of rod-like shaft 50 inserted therein over their entire peripheries. This structure also helps prevent accidental damages to magnets 39 since magnets 39 can be fixed without making them in contact directly with rod-like shafts 50. In this embodiment, flange portion 51 and fastening part 53 are press-fitted into spherical part 33 at both ends of rod-like shaft 50. However, the same advantages as above can be achieved only when either one of them is fitted.

For each of rotatable magnet members 30, the tip ends of shaft parts 35 are placed on corresponding terraces 63 inside straight grooves 62 in linear contact with terraces 63, and the outer peripheries of shaft parts 35 are supported by first to third supports 65, 67 and 69. In particular, first supports 65 and second supports 67 support the outer peripheries of shaft parts 35 at positions shifted with respect to each other along the axial direction of shaft parts 35. It becomes possible by this structure to provide sufficient clearances between the outer peripheries of shaft parts 35 and the individual supports 65 and 67 without causing a large backlash in shaft parts 35, thereby helping rotatable magnet members 30 to rotate smoothly. In the case of a structure having a rotatable shaft placed in open-top supports formed into a shape of the letter U to support the entire outer surfaces in the same periphery of the shaft, for instance, it is generally likely that rotation of the shaft is impeded if a foreign object is jammed between the circularly supported outer surface of the shaft and any of the supports. However, when the positions of first supports 65 and second supports 67 are shifted along the axial direction like the structure described in this embodiment, jamming of foreign objects or the like incidents can be reduced thereby achieving stable rotating operation for an extended period of time.

When the user makes a depressing manipulation from above spherical parts 33, or upper casing 80, with a finger or the like object, second outer projecting portion 76 is pressed downward with the lower end of first outer projecting portion 75 acting as a fulcrum. This causes pressing bump 77 to depress push switch 86, which in turn inputs a predetermined switching output to the controller unit of the apparatus. The controller unit of the apparatus performs a predetermined function of the apparatus according to the signal output from push switch 86. It is preferable that push switch 86 is a type that operates with a tactile response when depressed to help the user to become aware of the state of operation.

When the user removes the depressing force, push switch 86 lifts up pressing bump 77, and returns into the original state before being depressed, and mechanism unit 100a comes back also to the original state before being depressed.

In the input device of this embodiment, it is not likely that rotatable magnet members 30 are unintentionally turned to a considerable extent when the user depresses upper casing 80 including upwardly protruding spherical parts 33 with the finger in the manner as mentioned above. This is attributed to the small diameter of the individual spherical parts 33, and that magnets 39 inside spherical parts 33 are attracted to magnetic plate 72.

The predetermined functions of the apparatus mentioned above include such operation as moving a cursor in the display of the apparatus in response to the sliding manipulation of the user and entering a selected program by the depressing operation to name a few examples, but not limited to these.

Although what has been described in this embodiment is the structure comprising push switch 86 that is activated by the user depressing it via upper casing 80, this structure may be provided only when necessary, as it is not essential. In addition, the mechanism unit may have other configuration for activating push switch 86 without limiting to the structure described in this embodiment.

Moreover, description has been given above as an example comprising four rotatable magnet members 30 positioned in such a relation that they are at the centers of the individual segments of a square shape, but this is not meant to be restrictive. Furthermore, there can be any number of rotatable magnet members 30 or even one instead of four units. When such is the case, only what is necessary is to dispose a corresponding number of magnetic sensing elements 84 according to the arrangement of spherical parts 33 of rotatable magnet members 30.

### REFERENCE MARKS IN THE DRAWINGS

30 Rotatable magnet member
33 Spherical part
35 Shaft part
37 Through-hole portion
39 Magnet
40 Central through hole
41 First opening
42 First recess
44 First seating portion
46 Second opening
47 Second recess
48 Second seating portion
50 Rod-like shaft
50a First end
50b Second end
51 Flange portion
53 Fastening part
60 Lower casing
60a Dowel pin
61 Semi-spherical recess
61a Through hole
62 Straight groove
63 Terrace
65 First support
67 Second support
69 Third support
70 Magnetic plate setting channel
72 Magnetic plate
75 First outer projecting portion
76 Second outer projecting portion
77 Pressing bump
80 Upper casing
80a Fixing hole
80b Opening
82 Wiring board
84 Magnetic sensing element
86 Push switch

1. An input device comprising:
a rotatable magnet member including:
a magnet formed into a ring-shaped disc with a through hole in the center, and magnetized with N and S poles alternately along a circumferential direction thereof;
a spherical part formed of a resin covering the magnet except for an area opened into the through hole; and
a rod-like shaft having a flange portion near a first end, the shaft inserted in the through hole and both ends protrude from the through hole;
a lower casing rotatably supporting the rod-like shaft of the rotatable magnet member;
an upper casing provided with an opening for exposing an upper part of the rotatable magnet member to the exterior, the upper casing connected with the lower casing; and
a magnetic sensing element disposed in a position under the influence of magnetism of the magnet, wherein
a space is provided between an outer peripheral surface of a part of the rod-like shaft situating inside the through hole and an inner wall of the through hole over the entire peripheries, and
the flange portion is press-fitted and fixed to the spherical part.

2. The input device of claim 1, wherein the spherical part is provided with a first seating portion lying between the flange portion and one side of the magnet confronting the flange portion.

3. The input device of claim 1, further comprising a fastening part fitted in a second end of the rod-like shaft for fixing the rod-like shaft to the spherical part, wherein the fastening part is press-fitted and fixed to the spherical part.

4. The input device of claim 3, wherein the spherical part is provided with a second seating portion lying between the fastening part and another side of the magnet confronting the fastening part.

5. The input device of claim 1, wherein the lower casing comprises:
a straight groove for accommodating the rod-like shaft; and
a first support and a second support provided on an inner wall of the straight groove for supporting respective positions of the outer peripheral surface of the rod-like shaft, wherein
the positions of the rod-like shaft supported by the first support and the second support are shifted with respect to each other along an axial direction of the rod-like shaft.

6. The input device of claim 5, wherein the lower casing is provided with a terrace formed in a surface at the end of the straight groove, the terrace having a bottom surface situated above a bottom surface of the straight groove, and the rod-like shaft is supported on the terrace.

7. The input device of claim 5, wherein the lower casing further comprises a third support for supporting a tip end in the axial direction of the rod-like shaft.

8. The input device of claim 7, wherein each of the first support, the second support and the third support comprises a protrusion of a semi-circular cylindrical shape with a top view of crescent shape formed in the direction toward the rod-like shaft.

9. The input device of claim 1, wherein the spherical part is configured to be rotated in response to external manipulation so that the magnet rotates synchronously with the spherical part, and the magnetic sensing element detects a change in magnetism caused by rotation of the magnet.

10. The input device of claim 9, further comprising a magnetic plate for returning the rotatable magnet member to a rest state when the external manipulation has stopped.
